(19) United States
(12) Patent Application Publication
(10) Pub. No.: US 2014/0024515 A1
(43) Pub. Date: Jan. 23, 2014

(54) FOLDING DEVICE FOR ARTICLE PACKAGING

(71) Applicant: Krones Aktiengesellschaft, Neutraubling (DE)

(72) Inventor: Thomas Wimmer, Rosenheim (DE)

(21) Appl. No.: 13/944,221

(22) Filed: Jul. 17, 2013

(30) Foreign Application Priority Data
Jul. 23, 2012 (DE) DE202012102759.3

(51) Int. Cl. B31B 1/26

(52) U.S. Cl. CPC B31B 1/26
USPC 493/441

(57) ABSTRACT

A folding device for folding over a section or a flap of an outer packaging for articles includes at least one conveyor chain, push chain, and/or sealing chain, which chain in turn includes several pushing or folding elements spaced apart from each other and fastened to the chain at defined distances from each other. Each include a pushing or folding section protruding beyond the conveying plane. A coupling apparatus pivots the pushing or folding section of the respective pushing or folding elements in connection with a direction change and/or deflection of the conveyor, push, and/or sealing chain. Each pushing or folding element includes a carrier section connected to the chain and pivotable relative to the direction of chain movement via the coupling element and, fastened to this carrier section, each pushing or folding element further includes a pushing or folding section toollessly removable from the carrier section.

This claims the benefit of German Patent Application DE 20 2012 102 759.3, filed Jul. 23, 2012 and hereby incorporated by reference herein.

The present invention relates to a folding device for use in folding a section or a flap of a box blank to form the outer packaging for articles.

### BACKGROUND

A typical task in the packaging industry involves grouping and packing a plurality of similar types of products, such as individual beverage containers or bundles of several beverage containers, into a box or assembling them on a pad or a so-called tray for packaging. It is possible to use appropriately prefabricated box blanks for this purpose. The products are assembled into a desired, regular arrangement, for instance, and then positioned on the box blanks before the box blanks are folded around the products and fastened, for instance, by gluing overlapping sections of the boxes.

U.S. Pat. No. 4,642,967, for instance, discloses a retaining finger and a folding finger, both arranged on one common circulating conveyor chain, said fingers being used for folding upward the front and back bottom flap of a tray.

Beyond that, U.S. Pat. No. 3,555,776 A displays a machine for forming a tray around a group of articles. The machine possesses folding fingers in a leading position for folding up the front flaps of a box blank and folding fingers in a trailing position for folding up the rear flaps of a box blank, with each of the folding fingers being arranged on a circulating conveyor chain.

The schematic side view in FIG. 2 and the perspective view in FIG. 3 exhibit a folding device 2 as known from prior art, with a circulating conveyor chain 4 and one of several folding fingers 6 pivotably journaled thereon. The folding finger 6 protrudes vertically upward with the conveyor chain 4 being moved horizontally in transport direction 8 and comprises a pivot bearing 10 so that said folding finger 6 may pivot in the direction of the arrow 12 in a vertical plane running in parallel to the transport direction 8. The folding finger 6 is pivotably connected to a coupling rod 14 in a section of said folding finger 6 that protrudes downward beyond the extent or outlines of the conveyor chain 4, with said coupling rod 14, in turn, being pivotably hinged to a chain link of the conveyor chain 4 at some distance from the folding finger 6 and its appropriate pivot bearing 10. The coupling rod 14 serves for the pivoting movement of the top section of the folding finger 6 in direction of the arrow 12, said pivoting movement being effectuated as soon as the conveyor chain is deflected, thus causing a push or pull movement on the pivot bearing 10 of the folding finger 6, which effects a desired direction of movement for the folding finger 6 to fold over a box blank section of the outer packaging.

So-called conveyor or sealing chains, such as are exemplarily shown in FIGS. 2 and 3, may require that the pitch distances between consecutive folding fingers are changed in the case of a product change, so that the folding fingers are able to handle the entailing different size of the outer packaging. Unless a pitch distance can be changed as desired by removing individual folding fingers, it is usually necessary to change the respectively used conveyor or sealing chains in order to realize varying pitch distances in a machine. In this way, the pitch distances may be doubled or halved in the instance of using an even number of pushing elements or folding fingers. The commonly used 24-inch distance may be adjusted to a 48-inch distance by removing every other folding finger from a chain with a total of 16 folding fingers. By mounting 16 additional folding fingers, it is similarly possible to create a 12-inch distance.

In order to realize such changes in pitch distance, the folding fingers 6 have to be individually dismounted at their pivot bearings 10. While this is possible if common hexagon bolt connections 16 are used, it is a time-consuming process, as can be seen in FIG. 3. In addition, it is necessary to dismount the coupling rods 14, too, to prevent them from performing erratic movements that would interfere with the chain's motion.

An alternative variant for changing the pitch distance is to use mechanical connector systems as shown in the two drawings, FIG. 4a and FIG. 4b. In this variant, the folding finger 6 consists of a base section 6a that remains fixedly connected to the conveyor chain 4 and the coupling rod 14, while the removable top section 6b of the folding finger 6 may be extracted from the base section 6a in an upward direction 18 in parallel to the direction of the longitudinal extension of the folding finger 6 (FIG. 4b) after undoing the fastening elements of the top section with the use of a suitable tool (not shown here). The production of such a connector system is a relatively elaborate process, and a suitable tool is required for dismounting and mounting the folding fingers 6.

### SUMMARY OF THE INVENTION

It is an object of the present invention to provide a folding device for folding in a section or a flap of an outer packaging for articles, said folding device comprising a conveyor or sealing chain with several folding elements, such as folding fingers or the like, arranged on said chain in such a manner that they can be easily dismounted and remounted for attaining different pitch distances with little effort, in a short time, and without having to use special tools.

The present invention provides a folding device for folding over a section or a flap of an outer packaging for articles, such as beverage containers, said folding device comprising at least one conveyor chain, push chain, and/or sealing chain, said chain in turn comprising several pushing or folding elements, which are spaced apart from each other and fastened to the chain at defined distances from each other, and which each comprise a pushing or folding section protruding beyond the conveying plane of the chain. The folding device furthermore comprises coupling apparatuses for pivoting the pushing or folding section of the respective pushing or folding elements in connection with a direction change and/or deflection of the conveyor, push, and/or sealing chain. The invention provides that each pushing or folding element comprises a carrier section, which is connected to the chain and pivotable relative to the direction of chain movement by means of the coupling element and, fastened to this carrier section, each pushing or folding element further comprises a pushing or folding section, which is toollessly removable from the carrier section. In particular, it is possible for the pushing or folding section to have a form-locking and magnetically locking connection to the carrier section, thus enabling the removal of the pushing or folding section from the carrier section without making use of tools. The removable folding finger according to the invention therefore comprises a combination of form lock and magnetic lock. The assembly group may comprise a support and pivoting mechanism, which is fixedly mounted to the chain, and which comprises a receiving section. Two permanent magnets, for instance, may be located in the drilled holes of the receiving section, said magnets being suited for receiving the removable part with the two bolts. In a preferred variant, it is possible to extract and mount the removable part in a lateral direction to the direction of chain movement. Other variants are conceivable, which allow dismounting the removable part to the top or in any other direction.

In order to enable the toolless exchange of the individual pushing or folding sections of the folding device—commonly, so-called folding fingers are used—each of the pushing or folding sections may comprise at least one ferromagnetic section that engages with a permanent magnet arranged in the carrier section. This ferromagnetic section may correspond with a counterface and/or a counter outline on or in the carrier section, thus rendering settings unnecessary and faulty assembly impossible. In particular, it is possible for at least one ferromagnetic bolt on the pushing or folding section to correspond with a receiving section on or in the carrier section, at the base of which a permanent magnet is placed in such a manner that the permanent magnets serve for locking the releasable connection after form-lockingly inserting the connector bolts. There may of course also be a permanent magnet arranged at the removable section of the folding finger, said permanent magnet corresponding and engaging with a ferromagnetic section or portion of the carrier section.

A particularly reliably functioning embodiment variant of the folding device according to the invention may provide that the pushing or folding section or, as the case may be, the removable folding finger comprises two ferromagnetic bolts, which are spaced apart from and arranged in parallel to each other, said bolts corresponding with appropriately placed receiving sections at the carrier section. These parallel bolts may optionally both have the same size or else different sizes, and it is possible to use only one of them for engaging with a magnet, while the other one is only used for guiding purposes, if required. Of course, it is also possible that each of the two bolts, irrespective of whether they have the same size or different sizes, engages with a permanent magnet in order to ensure an even stronger grip than with the use of only one magnet. In this variant, the mounting or inserting direction of the pushing or folding section is reasonably carried out in perpendicular to the conveying direction of the chain and to the effective direction of the pushing or folding element, but other mounting directions are alternatively possible, although they may possibly require a higher production input.

On no account should the removable folding fingers come undone from the chain while the device is in operation, which requires the separation force for toollessly dismounting the pushing or folding section from the carrier section to be greater than the counteracting force exerted by folding or turning over the section or the flap of the outer packaging. In this way, disruptions in operation can be reliably prevented.

The pushing or folding sections may in each case be formed by folding fingers made of metal, a synthetic material, or a composite material. It is possible to double the pitch distance of the conveyor chain, push chain, and/or sealing chain by removing every other folding finger or every other pushing or folding section from the carrier section, which remains on the chain. By removing two folding fingers in each case, it is also possible to triple the pitch distance. The folding device may be equipped to realize numerous different pitch distances by mounting the carrier sections at relatively small pitch distances and accordingly mounting the folding fingers at the desired positions.

An alternative variant for changing the pitch distance may be an inventive modification to the prior art device shown in FIGS. 4a, 4b. The folding finger may be extracted vertically upward against the magnetic force of the permanent magnet in this variant, where it is only possible to provide one bolt with a corresponding receiving section due to the spatial conditions, so that additional measures are required to ensure a distortion lock of the folding finger at the carrier section. A base section may comprise a ferromagnetic bolt, for instance, which points vertically upwards. The removable top section of such a folding finger may be equipped with an accordingly adapted receiving section with a permanent magnet located inside so as to enable the folding finger to be slipped on from the top and locked by means of the magnetic force. Longitudinal guides formed by slots and pins may be used to prevent distortion.

Variations of the described embodiment variants are, of course, conceivable and comprised in the scope of protection of the invention as defined in the claims below. The permanent magnets may, for instance, also be arranged at the removable section of the folding finger and the corresponding ferromagnetic counterface located at the carrier section that is fixedly connected to the chain. Furthermore, the mounting direction does not necessarily have to be vertical to the direction of chain movement, but rather the directions of mounting and of chain movement may together enclose an acute or a dull angle. If required, the magnetic holder can additionally be combined with further securing devices, for instance a bayonet lock, a screw plug, or the like.

The term “ferromagnetic bolt” or “ferromagnetic section” as employed in the present context is not intended to imply that the entire bolt must be ferromagnetic. It suffices for the section that engages and comes into contact with the permanent magnets to comprise according ferromagnetic properties. The bolts and the corresponding receiving sections are, as a rule, cylindrically shaped elements and sections that require relatively low production input. Other, non-cylindrical geometries are, of course, alternatively possible for these elements. The bolt may, for instance, also have a conical form, a truncated cone form, or a non-circular cross section. The same applies to the corresponding receiving sections, into which the bolt is inserted for mounting the folding finger.

### BRIEF DESCRIPTION OF THE DRAWINGS

In the following passages, the attached figures further illustrate exemplary embodiments of the invention and their advantages. The size ratios of the individual elements in the figures do not necessarily reflect the real size ratios. It is to be understood that in some instances various aspects of the invention may be shown exaggerated or enlarged to facilitate an understanding of the invention.

FIG. 1 shows an embodiment variant of the folding device according to the invention in a schematic perspective view.

FIG. 2 shows a schematic side view of a first variant of a folding device as known from prior art.

FIG. 3 shows a schematic perspective view of a second variant of a folding device as known from prior art.

FIGS. 4a and 4b show two schematic perspective views of another embodiment variant of a folding device as known from prior art.

### DETAILED DESCRIPTION

It should be understood that the displayed embodiment variant of the device according to the invention, while indicating a preferred embodiment, is intended for purposes of illustration only and is not intended to limit the scope of the invention.

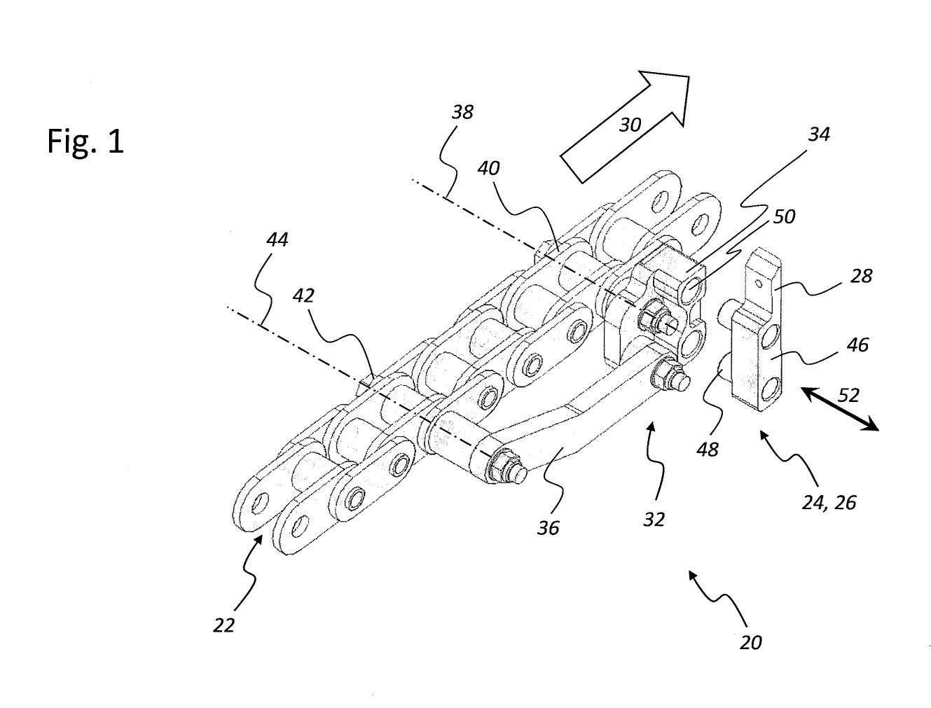

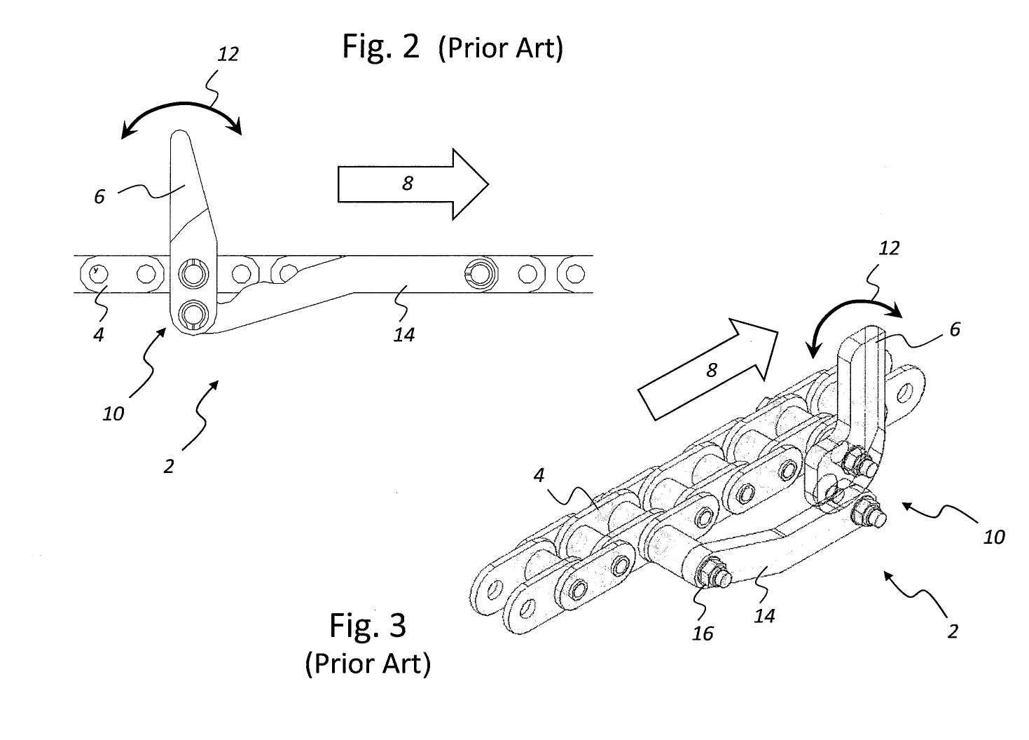

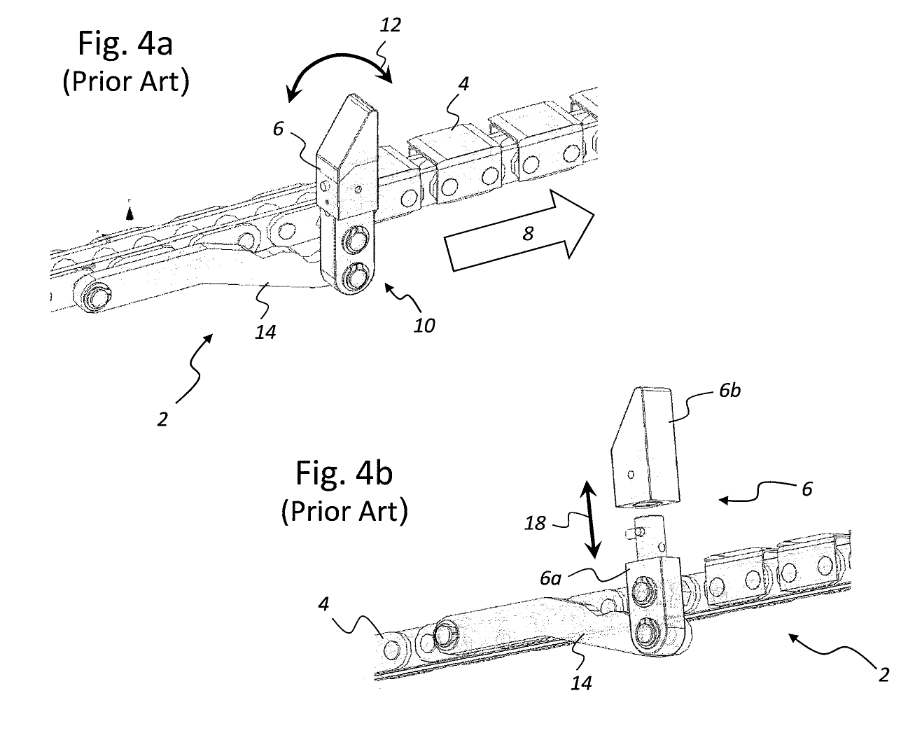

The schematic perspective view in FIG. 1 shows an embodiment variant of a folding device 20 according to the invention, said folding device serving the purpose of folding over a section or a flap of an outer packaging for articles, such as beverage containers or the like. The folding device 20 comprises a circulating conveyor chain, push chain, and/or sealing chain 22, referred to in the following as “conveyor chain 22”, on which several pushing or folding elements 24 are spaced at intervals and pivotably journaled. For matters of simplification, these pushing or folding elements 24 are referred to as “folding fingers 26” in the following. The pushing or folding elements 24 or folding fingers 26 are each fixedly arranged at defined distances from each other on the chain 22 and comprise a pushing or folding section 28, which protrudes beyond the conveying plane of the chain 22, and which comes into contact with the flaps of the outer packaging that are to be folded over. Each of the folding fingers 26 protrudes vertically upward with the conveyor chain 22 being moved horizontally in transport direction 30 and comprises a pivot bearing 32 so that each of said folding fingers 26 may pivot in a vertical plane running in parallel to the transport direction 30. The pushing or folding element 24 comprises a carrier section 34, which is pivotably journaled on the conveyor chain 22, and which may be pivoted together with the folding finger 26 by means of a coupling apparatus that is designed as a coupling rod 36 and serves for pivoting the pushing or folding element 24 along with the folding finger 26 in connection with a direction change and/or deflection of the conveyor, push, and/or sealing chain 22. The coupling rod 36 serves for the pivoting movement of the top section or of that section 28 of the folding finger 26 that is removable from the carrier section 34, said pivoting movement being effectuated as soon as the conveyor chain 22 is deflected, thus causing a push or pull movement on the pivot bearing 32 of the folding finger 26, which effects a desired direction of movement for the folding finger 26 to fold over a box blank section of the outer packaging.

According to the present invention, each pushing or folding element 24 comprises a carrier section 34, which is connected to the chain 22 and pivotable relative to the direction of chain movement 30 by means of the coupling element 36 and, fastened to this carrier section 34, each pushing or folding element 24 further comprises a pushing or folding section 28, which is toollessly removable from the carrier section 34, said pushing or folding section 28 forming the actual, exchangeable or removable folding finger 26. As can be seen in FIG. 1, the carrier section 34 is pivotably journaled on the chain 22, namely on the one of the two longitudinal sides of the chain 22 on which the coupling rod 36 is also arranged, so that the push or pull force of the coupling rod 36 results in the carrier section 34 being pivotable within a pivot plane that is arranged in vertical and in parallel to the direction of the chain movement 30. The pivot axis 38 of the pivot bearing 32, which is horizontally oriented and arranged orthogonally to the direction of the chain movement 30, is in alignment with that one of the chain links 40 onto which the carrier section 34 is also pivotably fastened. The coupling rod 36 is hinged to the carrier section 34 below the pivot axis 38, said coupling rod 36 being pivotably journaled with its other end to a chain link 42 spaced apart by two chain links, and namely pivotably journaled there about another pivot axis 44, which is arranged in parallel to the first pivot axis 38 of the carrier section 34.

In order to enable removing the individual pushing or folding sections 28 or the removable folding fingers 26 from the carrier section 34, each of the pushing or folding sections 28 or folding fingers 26 comprises at least one ferromagnetic section, which engages with a permanent magnet arranged in the carrier section 34. In the illustrated exemplary embodiment, the pushing or folding section 28 comprises a shaft section 46 having two ferromagnetic bolts 48 arranged in parallel to each other, which each correspond with a receiving opening 50 in the carrier section 34, at the base of which a permanent magnet is placed in such a manner that the permanent magnets serve for locking the releasable connection after form-lockingly inserting the connector bolts. The corresponding contact surfaces that come to lie against each other on inserting the bolts 48 into the receiving sections 50 are arranged in parallel to each other and in vertical to the direction of the longitudinal extension of the bolts 48, thus resulting in a form-locking connection without clearance when the two contacting parts 46 and 34 are placed in an accurately defined position in relation to each other.

In the illustrated exemplary embodiment, the parallel-arranged bolts 48 both have the same dimensions, but they may optionally have different sizes, and it is possible to use only one of them for engaging with a magnet, while the other one may only be used for guiding purposes, if required. Preferably, however, each of the two bolts 48, irrespective of whether they have the same size or different sizes, engages with a permanent magnet in the receiving opening 50 in order to ensure an even stronger grip than with the use of only one magnet. In this variant, the mounting or inserting direction 52 (indicated by the double arrow in FIG. 1) of the pushing or folding section 24 is carried out in perpendicular to the conveying direction 30 of the chain 22 and in perpendicular to the effective direction of the pushing or folding element 24 so that it is not possible to release the fixation of said pushing or folding element 24 while the chain 22 is running. On no account should the removable folding fingers 26 come undone from the chain 22 while the device is in operation, which requires the separation force for toollessly dismounting the pushing or folding section 24 from the carrier section 34 to be greater than the counteracting force exerted by folding or turning over the section or the flap of the outer packaging. In this way, disruptions in operation can be reliably prevented.

The pushing or folding elements 24 may in each case be formed by folding fingers 26 made of metal, a synthetic material, or a composite material. The bolts 48 may be pressed, screwed, or also molded into the shaft section 46. The permanent magnets arranged in the carrier section 34 may be, for instance, glued in, pressed in, or also screwed in. It is possible to double the pitch distance of the conveyor chain, push chain, and/or sealing chain 22 by removing every other folding finger 26 or every other pushing or folding section 24 from the carrier section 34, which remains on the chain 22. By removing two folding fingers 26 in each case, it is also possible to triple the pitch distance. The folding device 20 may be equipped to realize numerous different pitch distances by mounting the carrier sections 34 at relatively small pitch distances on the chain 22 and accordingly mounting the folding fingers 26 at the desired positions.

The bolts 48 may be cylindrical, just as the receiving openings 50. Optionally, conical or truncated cone forms with circular, oval or otherwise shaped cross sections of the bolts 48 and the receiving sections 50 are also possible.

The invention has been described with reference to a preferred embodiment. Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

### List of Reference Characters

2 Folding Device

4 Conveyor chain

6 Folding finger

6a Base section

6b Top section

8 Transport direction

10 Pivot bearing

12 Arrow direction, pivoting direction

14 Coupling rod

16 Hexagon nut, hexagon bolt connection

18 Mounting or dismounting direction

20 Folding Device

22 Conveyor chain, conveyor, push, and/or sealing chain

24 Pushing elements, folding elements

26 Folding finger

28 Pushing section, folding section, top section

30 Direction of transport, direction of chain movement

32 Pivot bearing

34 Carrier section

36 Coupling rod, coupling element

38 First pivot axis (of the pivot bearing)

40 First chain link

42 Second chain link

44 Second pivot axis (of the coupling rod)

46 Shaft section

48 Bolts, ferromagnetic bolts

50 Receiving section, receiving opening

52 Mounting or inserting direction

What is claimed is:

1. A folding device for folding over a section or a flap of an outer packaging for articles, the folding device comprising:
at least one of a conveyor chain, push chain, and sealing chain, the at least one chain including several pushing or folding elements spaced apart from each other and fastened to the chain at defined distances from each other, each pushing or folding element comprising a pushing or folding section protruding beyond the conveying plane of the chain;
a coupling apparatus for pivoting the pushing or folding section of respective pushing or folding elements in connection with a direction change and/or deflection of the at least one chain;
each pushing or folding element including a carrier section connected to the at least one chain and pivotable relative to the direction of chain movement via the coupling apparatus and, fastened to the carrier section, each pushing or folding element further including a pushing or folding section toollessly removable from the carrier section.

2. The folding device as recited in claim 1 wherein the pushing or folding section includes a form-locking and magnetically locking connection to the carrier section.

3. The folding device as recited in claim 2 wherein the pushing or folding section includes at least one ferromagnetic section engaging with a permanent magnet arranged in the carrier section.

4. The folding device as recited in claim 3 wherein the ferromagnetic section corresponds with a counterface and/or counter outline on or in the carrier section.

5. The folding device as recited in claim 3 wherein the ferromagnetic section includes a ferromagnetic bolt corresponding with a receiving section on or in the carrier section, the permanent magnet being placed at a base of the carrier section.

6. The folding device as recited in claim 3 wherein the ferromagnetic section includes two ferromagnetic bolts spaced apart from and arranged in parallel to each other, the ferromagnetic bolts corresponding with appropriately placed receiving sections on the carrier section.

7. The folding device as recited in claim 2 wherein a mounting or inserting direction of the pushing or folding section is oriented in perpendicular to the conveying direction of the chain and to the effective direction of the pushing or folding element.

8. The folding device as recited in claim 1 wherein a separation force for toollessly dismounting the pushing or folding section from the carrier section is greater than a counteracting force exerted by folding or turning over the section or the flap of the outer packaging.

9. The folding device as recited in claim 1 wherein the pushing or folding sections are in each case formed by folding fingers made of metal, a synthetic material, or a composite material.

10. The folding device as recited in claim 1 wherein a pitch distance of the at least one chain is doublable by removing every other folding finger or every other pushing or folding section from the carrier section, the carrier section remaining on the chain.

11. A method for changing a pitch distance of the folding device as recited in claim 10, the method comprising doubling the pitch distance by removing every other folding finger or every other pushing or folding section from the carrier section.

12. A method for the folding device as recited in claim 1 comprising toollessly removing the pushing or folding section.

13. The folding device as recited in claim 1 wherein the folding device is a beverage container packaging device.
